(19) United States
(12) Patent Application Publication
(10) Pub. No.: US 2026/0361001 A1
(43) Pub. Date: Nov. 12, 2026

(54) CONNECTOR

(71) Applicant: NIPPON STEEL TEXENG. CO., LTD., Tokyo (JP)

(72) Inventor: Mitsuo IWASAKI, Tokyo (JP)

(21) Appl. No.: 19/563,336

(22) Filed: Mar. 11, 2026

(30) Foreign Application Priority Data
Mar. 12, 2025 (JP) 2025-039641

(51) Int. Cl. H01R 4/18

(52) U.S. Cl. CPC H01R 4/183

(57) ABSTRACT

A connector connects a first crimp terminal and a second crimp terminal, the first crimp terminal being included at one end of a first cable, the second crimp terminal being included at one end of a second cable, and includes: a first assembly in a substantially cuboid shape including a first insertion port through which a crimp terminal side of the first cable is inserted and a first engagement portion; and a second assembly in a substantially cuboid shape including a second insertion port through which a crimp terminal side of the second cable is inserted and a second engagement portion, in which the first assembly and the second assembly are engageable with each other with the first engagement portion and the second engagement portion, and vent holes are provided on upper surfaces and bottom surfaces of the first assembly and second assembly, respectively.

### BACKGROUND OF THE INVENTION

### Field of the Invention

The present invention relates to a connector that connects a first cable and a second cable.

### Description of the Related Art

Conventionally, for cables for use in charge/discharge of a secondary battery, a connector that connects the cables is used for facilitating maintenance work.

Regarding such a connector, for example, Japanese Patent Laid-Open No. 2021-174693 describes a relay connector for the purpose of facilitating work of electrically connecting two pieces of equipment. This relay connector includes: a relay terminal including a first connecting portion that is connected to a terminal on a first equipment side and a second connecting portion that is connected to a terminal on a second equipment side; a sandwiching member including a first sandwiching portion that sandwiches, together with the first connecting portion, the terminal on the first equipment side and a second sandwiching portion that sandwiches, together with the second connecting portion, the terminal on the second equipment side; a lower case that holds the relay terminal; and an upper case that holds the sandwiching member. Further, in a connector case in a state in which the lower case and the upper case are assembled together, a first insertion port and a second insertion port are formed, and in the sandwiching member, a guiding portion is formed that guides the terminal on the first equipment side inserted through the first insertion port and the terminal on the second equipment side inserted through the second insertion port respectively between the first sandwiching portion and second sandwiching portion and the relay terminal.

However, recently, along with increasing capacity of the secondary batteries, the conducting current value of the connector has been increasing. Further, since generated heat due to joule heat is proportional to the square of current, the increasing current requires a further heat resistance of the connector. Meanwhile, charge/discharge devices for the secondary batteries are required to be reduced in size (space saving) so as to be effectively installed, and the connector used for the charge/discharge devices is also required to be reduced in size in addition to addressing the problem of heat generation due to joule heat.

Here, for cables connected by the connector, generally, a tin-plated wire and a crimp terminal are used. For the tin-plated wire, a tin (Sn) alloy layer (Cu6Sn5) is provided on the surface of a copper (Cu) stranded wire to take the oxidation prevention measure, but when the temperature of a crimp portion rises, the component (Cu3Sn) of the alloy interface changes due to tin diffusion, which forms a copper oxide on the surface, causing the contact resistance to increase (for example, see Japanese Patent Laid-Open No. 10-212585 and Kobe Steel Engineering Reports, Vol. 54, No. 1 (April 2004), Special issue on Electronic and electrical material/functional material “Tin-plated copper alloy strip”). Therefore, there has been a problem in that the connector cannot be used for a long period of time due to the increase in the resistance resulting from the tin diffusion (tin plating deterioration).

### SUMMARY OF THE INVENTION

Accordingly, an object of the present invention is to provide a connector capable of improving quality such as achieving a longer period of use as compared to the conventional connector by suppressing rising temperature of a crimp portion of a cable.

The connector according to the present invention is a connector adapted to connect a first crimp terminal and a second crimp terminal, the first crimp terminal being included at one end of a first cable, the second crimp terminal being included at one end of a second cable, the connector including: a first assembly in a substantially cuboid shape, the first assembly including a first insertion port through which a crimp terminal side of the first cable is inserted and a first engagement portion; and a second assembly in a substantially cuboid shape, the second assembly including a second insertion port through which a crimp terminal side of the second cable is inserted and a second engagement portion, in which the first assembly and the second assembly are engageable with each other with the first engagement portion and the second engagement portion, and vent holes are provided on a planar surface and a bottom surface of each of the first assembly and second assembly.

As a result, with the vent hole provided in each assembly, the rising temperature of the cable can be suppressed using the heat dissipation effect.

Further, the configuration is preferably made such that in the first assembly, a plurality of first insertion ports are provided side-by-side in a side view, and in the second assembly, a plurality of second insertion ports are provided side-by-side in the side view.

Note that for the first cable and the second cable, a tin-plated wire is preferably used.

In addition, the configuration is preferably made such the vent holes are each provided at least near a first connecting portion provided by staking between one end of the first cable and the first crimp terminal or near a second connecting portion provided by staking between one end of the second cable and the second crimp terminal.

Additionally, the first cable and the second cable of the connector according to the present invention are preferably cables to which a nominal voltage (an alternating current of 30 V or lower or a direct current of 60 V or lower) defined in NFPA79:2024 is applied.

According to the connector according to the present invention, it is possible to provide a connector capable of improving quality such as achieving a longer period of use as compared to the conventional connector by suppressing rising temperature of a crimp portion of a cable.

### BRIEF DESCRIPTION OF THE DRAWINGS

FIG. 1 is a schematic perspective view of a connector according to an embodiment of the present invention;

FIG. 2 is a schematic plan view of the connector according to the embodiment of the present invention; and

FIG. 3 is a view for explaining the configuration of a conventional connector.

### DETAILED DESCRIPTION OF THE INVENTION

Hereinafter, an embodiment of the present invention will be described in detail, but the description of each configuration requirement stated below is an example (representative example) of the embodiment of the present invention, and the present invention is not limited to the contents below unless its gist is changed.

### Connector

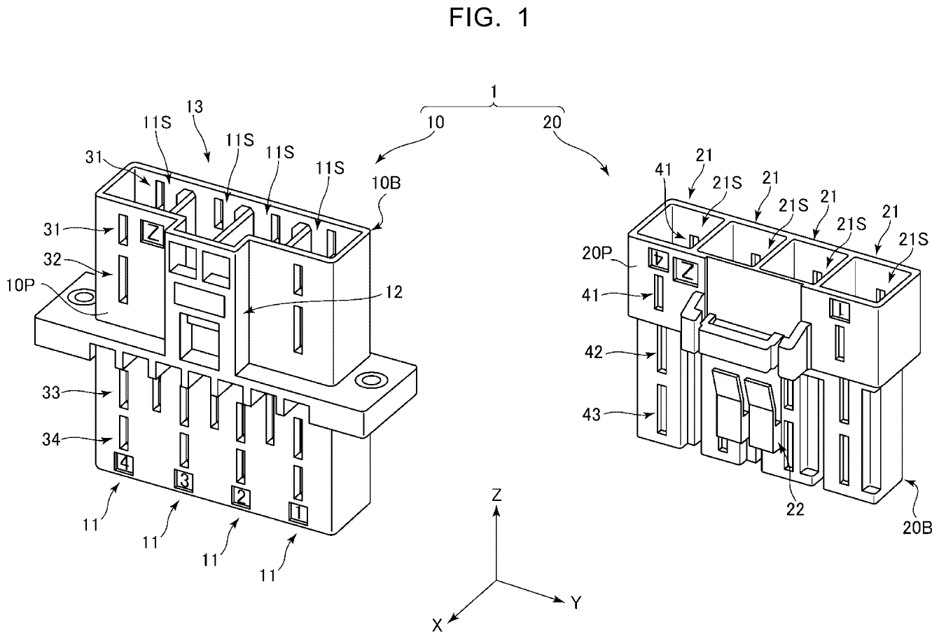

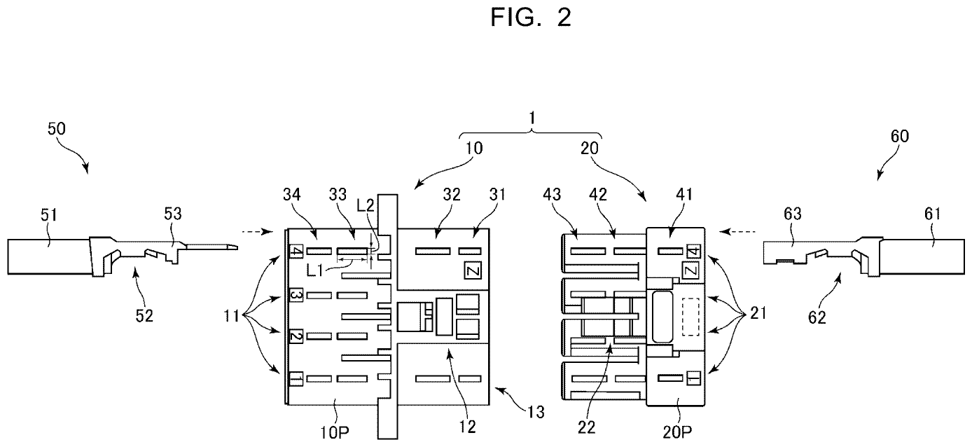

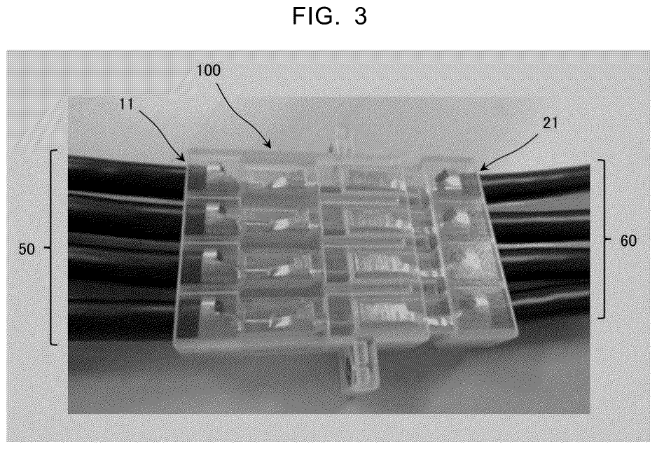

The configurations of a connector 1 according to the embodiment of the present invention will be described with reference to FIG. 1 and FIG. 2 while comparing them with the conventional configurations (FIG. 3). Note that in each drawing, the configurations having the same function are denoted by the same reference sign in the drawing and the detailed description will be omitted.

The connector 1 includes a first assembly 10 in a substantially cuboid shape and a second assembly 20 in a substantially cuboid shape. Here, in the present description, an X-direction, a Y-direction, and a Z-direction shown in FIG. 1 are assumed to be upward, forward, and rightward directions, respectively, and surfaces in the X-direction of the first assembly 10 and the second assembly 20 are assumed to be planar surfaces (planar surfaces 10P and 20P) and the opposing surfaces are assumed to be bottom surfaces (bottom surfaces 10B and 20B). Further, surfaces in the Y-direction of the first assembly 10 and the second assembly 20 are assumed to be front surfaces and the opposing surfaces are assumed to be rear surfaces. Note that surfaces in the Z-direction of the first assembly 10 and the second assembly 20 are assumed to be right side surfaces and the opposing surfaces are assumed to be left side surfaces.

The connector 1 is used in a state in which the first assembly 10 and the second assembly 20 are combined and a first cable 50 and a second cable 60 are connected and held inside the connector 1 (inside a first holding space 11S and a second holding space 21S which will be described later).

Further, the first assembly 10 includes a first engagement portion 12 and the second assembly 20 includes a second engagement portion 22. In addition, a side on a left side surface of the second assembly 20 is inserted into an opening 13 provided on a right side surface of the first assembly 10, and the first engagement portion 12 and the second engagement portion 22 engage with each other, so that the first assembly 10 and the second assembly 20 are combined.

Furthermore, the first assembly 10 includes, on a left side surface, a first insertion port 11 through which a first crimp terminal 53 side of the first cable 50 is inserted, and the second assembly 20 includes, on a right side surface, a second insertion port 21 through which a second crimp terminal 63 side of the second cable 60 is inserted (see FIG. 2). Further, the first cable 50 and the second cable 60 are inserted through the first insertion port 11 and the second insertion port 21 (hereinafter, simply referred to as the “insertion port”) into the first holding space 11S and the second holding space 21S, so that the crimp terminal side of each cable is held inside the connector 1 (inside the first holding space 11S and the second holding space 21S which will be described later).

Note that in the present embodiment, the first assembly 10 and the second assembly 20 are each provided with four insertion ports side-by-side in the front-rear direction (see FIG. 2). That is, in the connector 1 according to the present embodiment, up to four first cables 50 and up to four second cables 60 can be connected inside the respective four first holding spaces 11S and four second holding spaces 21S. It is obvious that the configuration of the connector 1 is not limited to the illustrated one, for example, the first assembly and the second assembly may be provided with two, six, or eight or more insertion ports so as to be able to hold two, six, or eight or more cables.

The configuration described above is the same for the configuration of a conventional connector 100 (FIG. 3).

### Vent Hole

The planar surfaces 10P and 20P and the bottom surfaces 10B and 20B of the first assembly 10 and the second assembly 20 are each provided with vent holes. In the connector 1 according to the present embodiment, up to four first cables 50 and up to four second cables 60 can be connected from the front to the rear (see FIG. 2) as described above. When the rearmost portion of those is explained as an example, on the planar surface 10P of the first assembly 10, four vent holes 31, 32, 33, and 34 are provided. Meanwhile, on the bottom surface 10B of the first assembly 10, four vent holes are provided in the same manner at the corresponding positions. Note that the other portions of the first assembly 10 may have the same configuration or any other configuration (for example, a configuration in which only the vent holes 33 and 34 are provided).

Further, on the planar surface 20P of the second assembly 20, three vent holes 41, 42, and 43 are provided. Meanwhile, on the bottom surface 20B of the second assembly 20, three vent holes are provided in the same manner at the corresponding positions. Note that the other portions of the second assembly 20 may have the same configuration or any other configuration (for example, a configuration in which only the vent hole 41 is provided).

In addition, in the present embodiment, the configuration is made such that when the first assembly 10 and the second assembly 20 are combined, the vent hole 31 and the vent hole 42 are situated at the same position and the vent hole 32 and the vent hole 43 are situated at the same position.

Note that in the present embodiment, the size L1×L2 (see FIG. 2) of each vent hole is “around 5 mm to 8 mm”×“around 1.5 mm to 2 mm,” but the design change can be made, as appropriate.

### First Cable and Second Cable

Subsequently, with reference to FIG. 2, the first cable 50 and the second cable 60 connected and held inside the connector 1 will be described. In the present embodiment, the first cable 50 (first crimp terminal 53) is a male terminal and the second cable 60 (second crimp terminal 63) is a female terminal.

Further, for a first cable main body 51 of the first cable 50 according to the present embodiment, a tin-plated wire is used, and at its one end, the first crimp terminal 53 is provided. Note that between one end of the first cable main body 51 and the first crimp terminal 53, a first connecting portion 52 provided by staking is present.

Meanwhile, for a second cable main body 61 of the second cable 60 according to the present embodiment as well, a tin-plated wire is used, and at its one end, the second crimp terminal 63 is provided. Note that between one end of the second cable main body 61 and the second crimp terminal 63, a second connecting portion 62 provided by staking is present.

Note that the first cable 50 and the second cable 60 according to the present embodiment are cables to which a nominal voltage (an alternating current of 30 V or lower or a direct current of 60 V or lower) defined in NFPA79:2024 is applied. As supplemental note, NFPA79:2024, “6. Protection against electric shock”-“6.4.2 PELV circuits shall satisfy all of the following conditions.”-“(1) The nominal voltage shall not exceed the following:”-“(a) 30 volts ac (rms value) or 60 volts dc (ripple-free) when the equipment is used in normally dry locations and when large area contact of live parts with the human body is not expected.”

### Position Where Vent Hole is Provided

Here, the connector 1 (the first assembly 10 and the second assembly 20) is provided with vent holes near the positions where the first connecting portion 52 and the second connecting portion 62 of the first cable 50 and the second cable 60, which are inserted through the insertion ports, are situated. In the present embodiment, the vent hole 33 of the first assembly 10 is provided near the position where the first connecting portion 52 is situated and the vent hole 42 of the second assembly 20 (and the vent hole 31 of the first assembly) is provided near the position where the second connecting portion 62 is situated.

Additionally, the vent hole 34 of the first assembly 10 is provided near the position where a portion between the first cable main body 51 and the first connecting portion 52 of the first cable 50 is situated. Further, the vent hole 43 (the vent hole 32 of the first assembly) of the second assembly 20 is provided near a position where the second crimp terminal 63 of the second cable 60 is situated. Note that the vent hole 41 of the second assembly 20 is provided near a position where a portion between the second cable main body 61 and the second connecting portion 62 of the second cable 60 is situated.

### Operation of Connector

Since the connector 1 is provided with the vent hole in each assembly in such a manner, and thus can suppress the rising temperature of the crimp portion of the cable, using the heat dissipation effect.

Here, the failure rate due to deterioration of the connector can be defined by the following equation considering knowhows as well, with reference to IEC61508 of the basic safety publications set by the International Electrotechnical commission.

connector life λ=“connector component failure rate λ_{ref}”×“crimping work quality πE”×“connector temperature environment πT”×“cable oxidation characteristic πC”×“damage criterion π K”×“stress profile π W”

As supplemental note on each parameter, for example, the failure rate of the connector component depends on manufacturers, types of connectors, or the like. Further, the crimping work quality depends on the crimping method such as manual crimping or automatic (machine) crimping. Meanwhile, the cable oxidation characteristic depends on the quality of plating (such as plating unevenness) of the cable. Note that the damage criterion is an indicator indicating the damage received due to the rising temperature and the stress profile is an indicator related to the stress.

Further, regarding the connector life, the temperature environment of the connector is particularly important. Essentially, to improve the connector life, it is important to suppress heat generation due to the joule heat that is a factor in the rising temperature (heat generation) of the connector.

Considering such a fact, since the connector 1 is provided with the vent holes near the positions where the first connecting portion 52 and the second connecting portion 62 of the first cable 50 and the second cable 60, which are inserted through the insertion ports, are situated, the heat generation due to the joule heat can be effectively suppressed.

More specifically, the first connecting portion 52 and the second connecting portion 62 are provided by staking and thus are thin, which is likely to cause plating unevenness (difference in the plating thickness). Therefore, when the temperature of this portion rises, the factor of the temperature environment of the connector is added to the cable oxidation characteristics, which significantly affects the connector life. Essentially, with such a configuration, the connector 1 can effectively suppress the rising temperature near the first connecting portion 52 and the second connecting portion 62 of the first cable 50 and the second cable 60 and the other portions.

The outline of the verification result of the present invention is that in the case of the conventional configuration, the temperature of the connector could rise to 60 °C to 90 °C or higher, whereas in the case of the connector according to the present invention, a lower temperature by 12 °C to 45 °C as compared to the conventional one was confirmed.

Further, the connector according to the present invention does not require a cooling device (fan) or a cooling member separately provided to prevent the rising temperature, and thus can also address the demand for downsizing as described above.

Note that the first cable and the second cable of the connector according to the present invention are cables to which a low voltage (an alternating current of 30 V or lower or a direct current of 60 V or lower) is applied. Since the voltage range is an admissible touch voltage, even when the vent holes are provided in the connector, the safety can be secured.

The present embodiment described above is merely one example, and for each configuration, design change can be made as appropriate, unless it departs from the gist of the present invention. For example, the number or size, location, and the like of the vent holes provided in the first assembly and the second assembly are not limited to those illustrated, and design change can be made as appropriate.

Further, the vent holes may be provided so as to correspond to both the planar surface and the bottom surface of each of the first assembly and the second assembly or may be provided only on either one of the planar surface and the bottom surface. As long as the vent hole is provided on either one of the planar surface and the bottom surface of each of the first assembly and the second assembly, the connector according to the present invention can fully exhibit the aforementioned advantageous effects.

Note that the shape of the first assembly and the second assembly is not limited to the substantially cuboid shape illustrated in FIG. 1 and FIG. 2, either.

### INDUSTRIAL APPLICABILITY

The present invention is a connector capable of improving quality such as achieving a longer period of use as compared to the conventional connector by effectively suppressing rising temperature of a crimp portion of a cable and can be used for various applications including charge/discharge inspection and in various locations, and thus can be industrially useful.

### REFERENCE SIGNS LIST

1 connector
10 first assembly
10P planar surface of first assembly
10B bottom surface of first assembly
11 first insertion port
11S first holding space
12 first engagement portion
13 opening
20 second assembly
20P planar surface of second assembly
20B bottom surface of second assembly
21 second insertion port
21S second holding space
22 second engagement portion
31, 32, 33, 34, 41, 42, 43 vent hole
50 first cable
51 first cable main body
52 first connecting portion
53 first crimp terminal
60 second cable
61 second cable main body
62 second connecting portion
63 second crimp terminal

The entire disclosure of Japanese Patent Application No. 2025-039641 filed on Mar. 12, 2025 including specification, claims, drawings and summary is incorporated herein by reference in its entirety.

1. A connector adapted to connect a first crimp terminal and a second crimp terminal, the first crimp terminal being included at one end of a first cable, the second crimp terminal being included at one end of a second cable, the connector comprising:
a first assembly in a substantially cuboid shape, the first assembly including a first insertion port through which a crimp terminal side of the first cable is inserted and a first engagement portion; and
a second assembly in a substantially cuboid shape, the second assembly including a second insertion port through which a crimp terminal side of the second cable is inserted and a second engagement portion,
wherein the first assembly and the second assembly are engageable with each other with the first engagement portion and the second engagement portion, and
vent holes are provided on an upper surface and a bottom surface of each of the first assembly and second assembly.

2. The connector according to claim 1, wherein
in the first assembly, a plurality of the first insertion ports are provided side-by-side in a side view, and
in the second assembly, a plurality of the second insertion ports are provided side-by-side in the side view.

3. The connector according to claim 1, wherein for the first cable and the second cable, a tin-plated wire is used.

4. The connector according to claim 1, wherein the vent holes are each provided at least
near a first connecting portion provided by staking between one end of the first cable and the first crimp terminal and
near a second connecting portion provided by staking between one end of the second cable and the second crimp terminal.

5. The connector according to claim 4, wherein the first cable and the second cable are cables to which a nominal voltage (an alternating current of 30 V or lower or a direct current of 60 V or lower) defined in NFPA79:2024 is applied.
